(19) United States
(12) Patent Application Publication
(10) Pub. No.: US 2009/0221170 A1
(43) Pub. Date: Sep. 3, 2009

(54) Adaptive Plug With Discriminating Functionality

(75) Inventors: Petri Vuori, Salo (FI); Pekka Leinonen, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 12/087,322

(22) PCT Filed: Dec. 28, 2006
(86) PCT No.: PCT/IB2006/003789

§ 371 Date: Feb. 9, 2009

Related U.S. Application Data
(60) Provisional application No. 60/754,837, filed on Dec. 29, 2005.

(51) Int. Cl. H01R 13/642

(52) U.S. Cl. 439/223

(57) ABSTRACT

A charging plug for charging a mobile terminal, includes a plug element for carrying current, and also includes a portion extending beyond the plug element.

That portion is long enough to prevent the plug element from contacting the mobile terminal, if the mobile terminal requires a smaller current. However, the portion is short enough to allow the plug element to contact the mobile terminal if the mobile terminal is equipped to handle the current carried by the plug element. According to an additional embodiment, the portion extending beyond the plug element will provide the smaller current if the smaller current is required.

### FIELD OF THE INVENTION

The present invention relates to wireless communication, and more particularly to charging interfaces for mobile terminals.

### BACKGROUND OF THE INVENTION

It is known that a rechargeable device can be recharged by a relatively high current in order to be recharged faster. However, it is important that a charger providing a high current not be used with a rechargeable device that cannot accept that high current. Permanent damage to a wireless terminal (e.g. a mobile phone) can be caused by attempting to charge the terminal with a current that exceeds specifications.

Normal wireless phones cannot support high-current charging as such. Reasons for this include the cost and size of electronics needed to support a charging current exceeding one ampere, and also heating problems in small-sized terminals. However, high-current terminals are feasible.

One solution to avoid the over-charging problem would be if the high-current phones are recharged using chargers that cannot be used with normal phones, and if the normal phones are recharged using chargers that cannot be used with the high-current phones. However, this is an expensive solution that would require an entirely separate charging system for the two different types of phones. It would be very preferable if recharging systems would be sufficiently agile so that different recharging equipment would not always be needed for the two types of terminals.

It is not only desirable that a high-current phone can be charged with a standard charger, but also that the reverse can be done, without damaging either of the phones. High-current chargers are very useful for reducing charging delays, but on the other hand normal terminals cannot handle current in excess of one ampere. A mechanism to prevent accidental charging of a normal phone with a high current charger must be developed.

Also, from a manufacturing point of view, it would be better to not produce a different diameter plug interface for different charging interface versions, or to make different shapes for the plug. If parts are similar, then manufacturing costs will be less.

In the future, mobile terminal manufacturers will market mobile terminals that charge at different rates. It is essential that high-current chargers cannot be accidentally used with “normal phones.” Normal phones must not accept high-current chargers. This can be accomplished many ways. The software in a normal phone could be designed to reject the high-current chargers, but this would not be very convenient for the consumer, as the plugs would look the same. Nevertheless, making completely different interfaces for high-current chargers is not desirable, because it would be desirable good if normal chargers could be used for charging the high-current supporting phones also.

### SUMMARY OF THE INVENTION

The present invention ensures that a normal charger can be used with either a normal terminal or with a high current terminal, while also ensuring that the high current charger cannot provide a high current to the normal terminal. Furthermore, it is also possible for a single plug to function as both a high current charger and as a normal charger.

It is possible to employ a fully mechanical approach in order to ensure that a normal charger can be used with either a normal terminal or with a high current terminal, while also ensuring that the high current charger cannot provide a high current to the normal terminal. This is done by implementing a longer plug for high-current chargers. Using the high-current charger in a normal phone is mechanically prevented. The high-current plug does not make contact with the standard jack. However, the standard plug operates correctly with the high-current jack.

Moreover, it is also possible for a high-current charger to be used in a normal charging mode with normal phones, by employing a dual ground implementation of the recharging plug. It may also be remarked that the functionality of the fully mechanical implementation can be combined with that of the dual ground implementation. It is possible to implement three versions of chargers that would be compatible with high-current-supporting phones: a high-current only-charger, a dual-mode charger (supporting both high-current and standard charging), and a standard charger.

### BRIEF DESCRIPTION OF THE DRAWINGS

FIG. 1 shows a normal charging arrangement alongside a high current charging arrangement according to an embodiment of the present invention.

FIG. 2 shows a high current plug being used with a normal terminal and vice versa, according to an embodiment of the present invention.

FIG. 3 shows a plug capable of operating as a high current plug or a low current plug, according to an embodiment of the present invention.

### DETAILED DESCRIPTION OF THE INVENTION

The present invention describes a system for recharging a mobile terminal using a higher-than-normal current, or using a normal current, the mobile terminal being either able or unable to accommodate the higher-than-normal current. The invention can be further appreciated by reference to the embodiments shown in the accompanying figures.

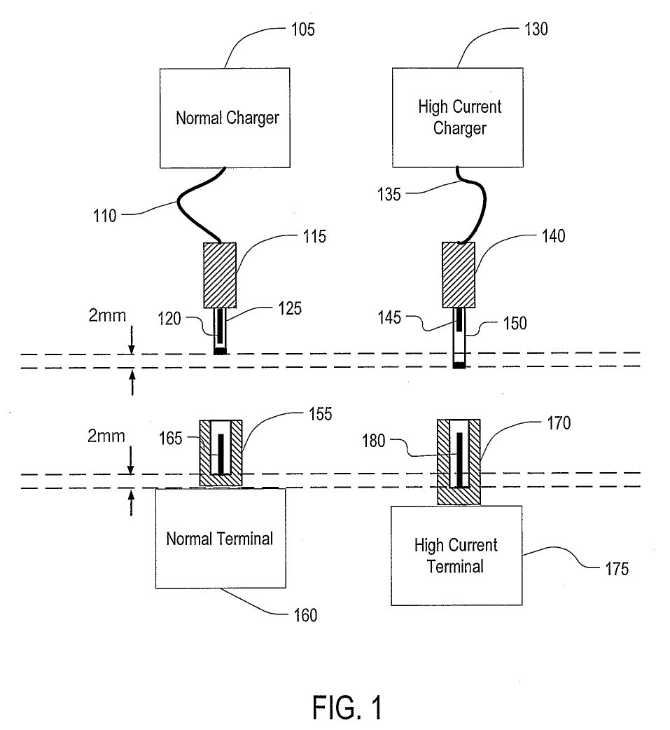

As seen in FIG. 1, a normal charger 105 is connected by wire 110 to a normal charging plug 115. The plug 115 includes a plug element 120 as well as a portion 125 that extends beyond the plug element.

The high-current charger 130 has a similar arrangement, including a wire 135 connecting to a high-current plug 140 that has a high-current plug element 145 and a portion 150 that extends beyond the high-current plug element. Notice that the dimensions of these two plugs are somewhat different, as shown in FIG. 1.

The normal charging plug 115 plugs into a jack 155 of a normal terminal 160, the normal jack 155 including a jack element 165 that comes into contact with the plug element 120 at which point the current flows from the normal charger to the normal terminal.

Likewise, the high-current charging plug 140 plugs into a jack 170 of a high-current terminal 175, the jack 170 including a jack element 180 that comes into contact with the plug element 145 at which point the current flows from the high-current charger to the high-current terminal. Notice that the dimensions of these two jacks are somewhat different, as shown in FIG. 1.

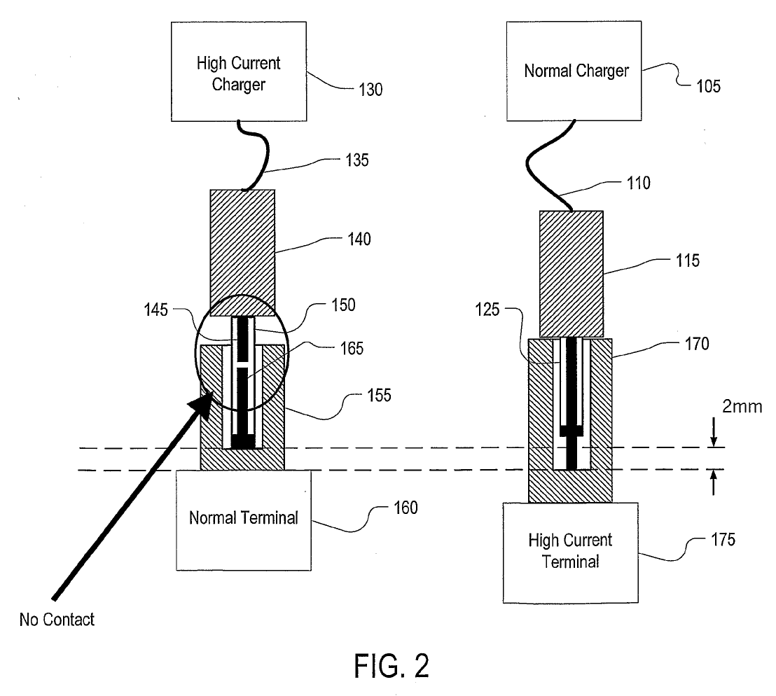

FIG. 2 shows what happens if the plugs and jacks are crossed; i.e. if the high-current plug 140 is inserted into the normal jack 155, and the normal plug 115 is inserted into the high-current jack 170. The high current is not able to flow into the normal terminal 160, but the normal current does flow into the high-current terminal 175. Thus, the present invention allows the normal charger 105 to be safely used to charge up either type of terminal, whereas the high current charger 130 is carefully barred from overcharging the normal terminal 160 because the plug element 145 does not reach the jack element 165.

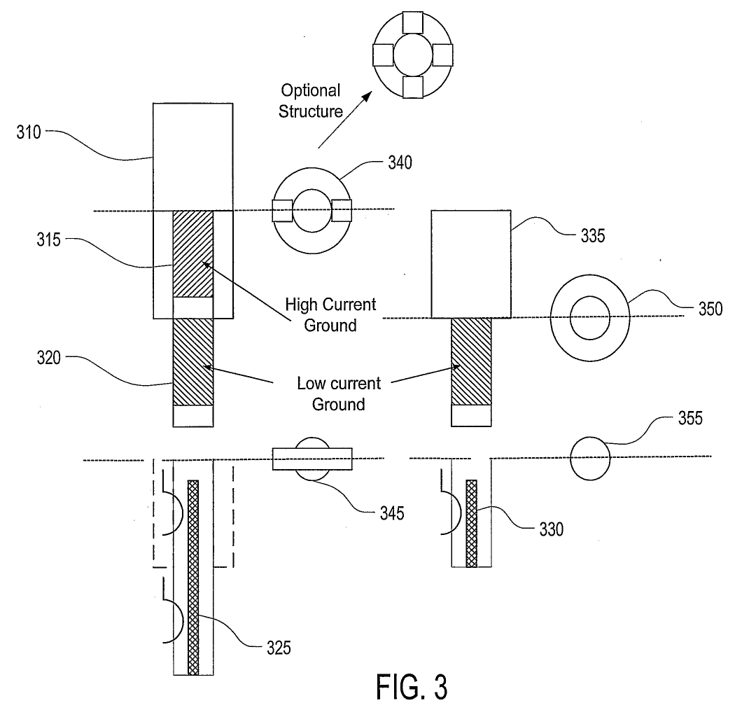

Turning now to FIG. 3, this shows an additional embodiment of the present invention, where the plug 310 includes a high-current plug element 315 and a portion 320 that extends beyond the plug element. Unlike the high-current plug 140 in FIG. 2, the plug 310 in FIG. 3 can be used to supply current to not just the high-current jack element 325, but also to the normal jack element 330. Likewise, the normal plug 335 can also be used to supply current to either jack. The plug 310 is able to provide two different levels of current, depending upon whether the jack element only reaches the portion 320 where the low current is available, or instead reaches all the way to the plug element 315 where the high current is available.

If a person uses the plug 310 to charge the jack element 325, then the user may twist the plug to a position where it can be fully inserted onto the jack element 325, and the pieces 340 and 345 show how the jack and the plug can be aligned. In contrast, the normal plug and jack do not have any pieces 350, 355 with these aligning characteristics. Regarding FIG. 3, both jacks are compatible with both plugs, although this is not the case for the embodiment shown in FIG. 1 and FIG. 2.

It is to be understood that all of the present figures, and the accompanying narrative discussions of best mode embodiments, do not purport to be completely rigorous treatments of the method, terminal, and system under consideration. A person skilled in the art will understand that the steps and signals of the present application represent general cause-and-effect relationships that do not exclude intermediate interactions of various types, and will further understand that the various steps and structures described in this application can be implemented by a variety of different combinations of hardware and software which need not be further detailed herein.

What is claimed is:

1. A charging plug, comprising:
a plug element configured to carry a first current;
a portion extending beyond an end of the plug element,
wherein said portion is long enough to prevent the plug element from contacting a mobile terminal if the mobile terminal requires a second current that is less than the first current.

2. The charging plug of claim 1, wherein the portion is short enough to allow the plug element to contact the mobile terminal if the mobile terminal is equipped to handle the first current.

3. The charging plug of claim 1, wherein the portion is for carrying the second current.

4. The charging plug of claim 1, wherein the portion has a second current ground that is less than a first ground of the plug element.

5. The charging plug of claim 4,
wherein the charging plug has at least one groove or protuberance for alignment with the mobile terminal, if the mobile terminal is equipped to handle the first current, and
wherein said alignment allows the plug element to contact the mobile terminal, and lack of said alignment prevents the plug element from contacting the mobile terminal.

6. A mobile terminal comprising:
a jack element for receiving a charge; and
a battery for storing the charge,
wherein the jack element is sufficiently long to contact a second current,
wherein the jack element has added length for contacting a first current, and
wherein the second current is less than the first current.

7. The mobile terminal of claim 6, wherein the jack element is configured to be charged by the first current if a plug element is sufficiently long to reach the first current, and is further configured to otherwise be charged by the second current.

8. A system for charging mobile terminals, comprising:
a first mobile terminal having a first jack;
a second mobile terminal having a second jack;
a first current charger including a first plug element for carrying a first current;
a second current charger having a second plug element for carrying a second current that is less than the first current;
wherein the second jack has a second jack element that is shorter than a first jack element of the first jack,
wherein the first jack element is long enough to reach either the first plug element or the second plug element, and
wherein the second jack element is too short to reach the first plug element, but long enough to reach the second plug element.

9. The system of claim 8,
wherein the first current charger further includes a portion for carrying the second current, and
wherein the second jack element is long enough to reach the portion carrying the second current.

10. A charging plug, comprising:
first means, for carrying a first current;
second means, for extending beyond an end of the first means,
wherein said second means is long enough to prevent the plug element from contacting a mobile terminal if the mobile terminal requires a second current that is less than the first current.

11. The charging plug of claim 1, wherein the second means is short enough to allow the first means to contact the mobile terminal if the mobile terminal is equipped to handle the first current.
